(19) United States
(12) Patent Application Publication
(10) Pub. No.: US 2012/0028562 A1
(43) Pub. Date: Feb. 2, 2012

(54) FLEXIBLE AIR DUCTS WITH GRADUAL INFLATION

(76) Inventors: Frank Heim, Platteville, WI (US); Jeffrey Klopfenstein, Dubuque, IA (US); Kevin J. Gebke, Dubuque, IA (US); Nicholas L. Kaufman, Sherill, IA (US); William A. Niehaus, Holy Cross, IA (US)

(21) Appl. No.: 12/844,631

(22) Filed: Jul. 27, 2010

(51) Int. Cl. F24F 11/00; F24F 13/10; F16L 11/00

(52) U.S. Cl. 454/255; 138/118.1; 454/333

(57) ABSTRACT

Example air duct systems for supplying conditioned air to comfort zones include various example inflatable tubes with various example dampers. The dampers move noticeably slowly and/or its opening is delayed to reduce the rate at which the tube is inflated by a supply air blower. Depending on the particular example, the damper can be either at the inlet end of the tube or at the tube's opposite end. In some examples, the damper is controlled by an actuator that is powered by air or driven by an electric motor.

### FIELD OF THE DISCLOSURE

This patent generally pertains to flexible air ducts and, more specifically, to flexible air ducts that are inflatable.

### BACKGROUND

Sheet metal ductwork is often used for conveying conditioned air to a comfort zone, such as a room or other areas of a building. Metal ducts, however, can be expensive, unsightly, and susceptible to condensation. Moreover, such ducts usually require supply air registers that discharge air into the comfort zone at localized areas rather than evenly distributing the air. Consequently, inflatable air ducts, such as those made of pliable fabric, are often preferred over conventional sheet metal ones.

Inflatable air ducts typically comprise an inflatable tube made of fabric or otherwise pliable material and are also used for conveying conditioned air to comfort zones. A blower at the inlet of the duct is selectively activated to supply conditioned air as needed. The air discharged from the blower inflates the duct to create a radially expanded tubular conduit that conveys the air along the length of the inflated tube. The pliable wall of the tube can be porous and/or be perforated along its length for evenly or strategically dispersing air from within the duct into the areas being conditioned or ventilated.

Inflatable air ducts are often suspended from a horizontal cable or track mounted just below the ceiling of a building. In other cases, inflatable ducts are installed beneath a floor and supply conditioned air to a comfort zone by releasing the air up through one or more openings in the floor.

### BRIEF DESCRIPTION OF THE DRAWINGS

FIG. 1 is a side view of an example air duct system with a schematically illustrated example damper in an initial configuration.

FIG. 2 is a side view of the air duct system of FIG. 2 but showing the damper in an operating configuration.

FIG. 3 is a side view of another example air duct system with a schematically illustrated example damper in an initial configuration and with an example inflatable tube in a deflated state.

FIG. 4 is a side view of the air duct system of FIG. 3 but showing the damper in an operating configuration and showing the tube in an inflated state.

FIG. 5 is a cross-sectional side view of another example air duct system with an example damper in an initial configuration.

FIG. 6 is a cross-sectional side view of the air duct system of FIG. 5 but showing the damper in an operating configuration.

FIG. 7 is a cross-sectional side view of another example air duct system with an example damper in an initial configuration.

FIG. 8 is a cross-sectional side view of the air duct system of FIG. 7 but showing the damper in an operating configuration.

FIG. 9 is a cross-sectional side view of another example air duct system with an example damper in an initial configuration.

FIG. 10 is a cross-sectional side view of the air duct system of FIG. 9 but showing the damper moving to an operating configuration.

FIG. 11 is a cross-sectional side view of the air duct system of FIG. 9 but showing the damper in its operating configuration.

FIG. 12 is a cross-sectional side view similar to FIG. 11 but showing an example actuator in a relaxed state.

FIG. 13 is a cross-sectional side view of another example air duct system with an example damper in an initial configuration.

FIG. 14 is a cross-sectional side view of the air duct system of FIG. 13 but showing the damper in its operating configuration.

FIG. 15 is a cross-sectional side view of another example air duct system with an example damper in an initial configuration.

FIG. 16 is a cross-sectional side view of the air duct system of FIG. 15 but showing the damper in its operating configuration.

FIG. 17 is a cross-sectional side view of another example air duct system with an example damper in an initial configuration.

FIG. 18 is a cross-sectional side view of the air duct system of FIG. 17 but showing the damper in its operating configuration.

FIG. 19 is a cross-sectional side view of another example air duct system with an example damper in an initial configuration.

FIG. 20 is a cross-sectional side view of the air duct system of FIG. 19 but showing the damper in its operating configuration.

FIG. 21 is a cross-sectional side view of another example air duct system with an example damper in an initial configuration.

FIG. 22 is a cross-sectional side view of the air duct system of FIG. 21 but showing the damper in its operating configuration.

FIG. 23 is a side view of another example air duct system with an example damper in an initial configuration.

FIG. 24 is a side view of the air duct system of FIG. 23 but with the damper in the operating configuration.

FIG. 25 is a cross-sectional view taken along line 25-25 of FIG. 23.

FIG. 26 is a cross-sectional view taken along line 26-26 of FIG. 24.

FIG. 27 is a side view of another example air duct system with an example damper in an initial configuration.

FIG. 28 is a side view of the air duct system of FIG. 27 but with the damper in the operating configuration.

FIG. 29 is a side view of another example air duct system with an example damper in an initial configuration.

FIG. 30 is a side view of the air duct system of FIG. 29 but with the damper in the operating configuration.

### DETAILED DESCRIPTION

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness. Additionally, several examples have been described throughout this specification.

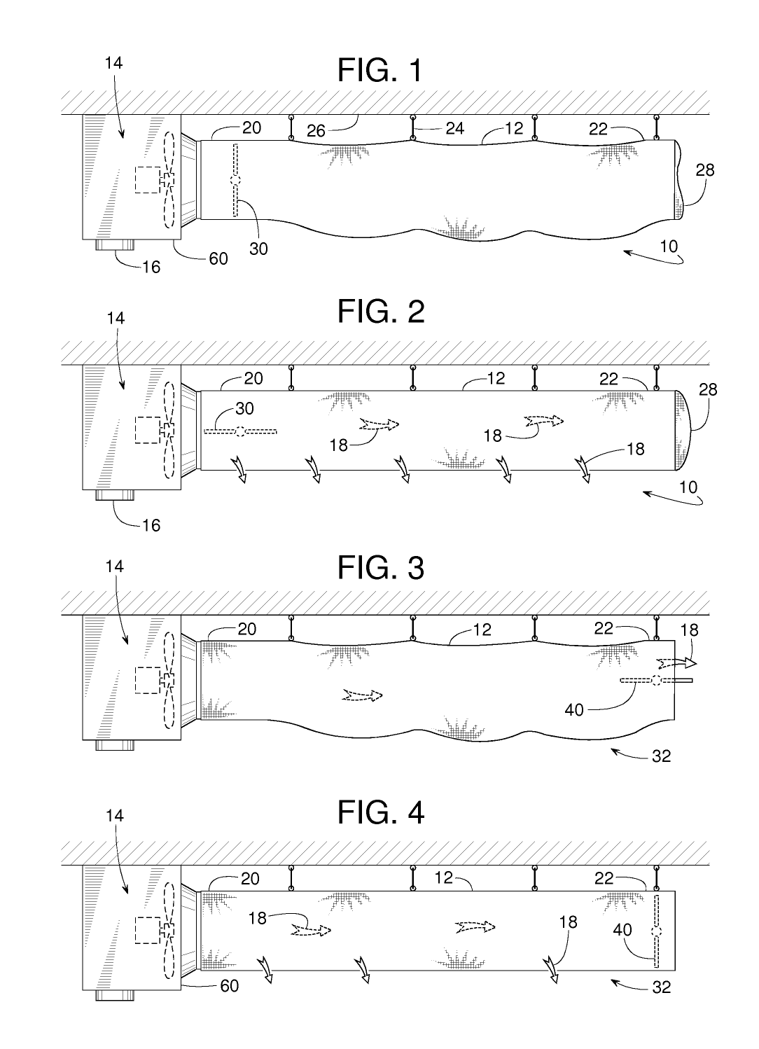

FIGS. 1 and 2 show an example air duct system 10 comprising an inflatable tube 12 connected to a source of air (e.g., a blower 14). In this example, blower 14 draws in air from an inlet 16 and discharges a current of air 18 through tube 12. As air 18 flows from an upstream end 20 of tube 12 to a downstream end 22, pores and/or other openings along the tube's length distribute air 18 to a comfort zone, such as a room or other areas in a building.

In some examples, tube 12 includes a pliable fabric or other pliable sheet of material. In the illustrated example, a series of hangers 24 suspends tube 12 from an overhead supporting structure 26 (e.g., a ceiling or beam). In other examples, tube 12 is installed in other locations such as, along a wall, just above a floor, or even below a floor. When blower 14 is inactive, the resulting relatively low static air pressure within tube 12 allows tube 12 to become generally limp in a deflated state, as shown in FIG. 1. When blower 14 is active and pressurizes tube 12 with relatively high static air pressure, tube 12 inflates to an inflated state with the tube's sidewalls becoming taut, as shown in FIG. 2. In this example, an end cap 28 is attached to the tube's downstream end 22 to help ensure that tube 12 can fully inflate.

To prevent tube 12 from suddenly inflating immediately upon energizing blower 14, air duct system 10 includes a damper 30. Upon energizing blower 14, damper 30 moves relatively slowly from an initial configuration (FIG. 1) to an operating configuration (FIG. 2). In the example where damper 30 is at the tube's upstream end 20, damper 30 provides a greater obstruction to airflow when damper 30 is in the initial configuration than in the operating configuration. The flow obstruction provided by damper 30 being in the initial configuration controls (e.g., limits) the flow of air 18 from blower 14 to tube 12 and, thus, causes tube 12 to inflate relatively slowly or controllably. When tube 12 is fully inflated, or nearly so, damper 30 will have moved to its operating configuration to minimize the damper's obstruction to airflow through tube 12.

Additionally or alternatively to installing damper 30 at the tube's upstream end 20, FIGS. 3 and 4 show an example air duct system 32 wherein a damper 40 is installed at downstream end 22 to prevent tube 12 from suddenly inflating immediately upon energizing blower 14. Upon energizing blower 14, damper 40 moves relatively slowly from an initial configuration (FIG. 3) to an operating configuration (FIG. 4). In this example, damper 40 provides a greater obstruction to airflow when damper 40 is in the operating configuration than in the initial configuration.

While blower 14 is energized, the flow obstruction provided by damper 40 being generally closed in the operating configuration blocks off an otherwise open downstream end of tube 12 (end cap 28 is eliminated in this example). Blocking off the tube's downstream end 22 allows blower 14 to create a relatively high static air pressure that is sufficient to fully inflate tube 12 during the air duct system's normal steady-state operation. When blower 14 is first energized, damper 40 being in a generally open initial configuration releases air 18 out through the open downstream end 22 of tube 12. Air escaping out through the tube's open downstream end 22 keeps air 18 at a relatively low static air pressure that slowly or controllably inflates tube 12.

Dampers 30 and 40 are schematically illustrated in FIGS. 1-4 to represent any structure or flow regulating means that can provide a variable obstruction to airflow. Examples of dampers 30 and 40 include, but are not limited to, a single butterfly damper blade (e.g., generally round or generally rectangular), a series of generally parallel damper blades (moving independently or in unison), a fabric or otherwise flexible sheet of material (e.g., deformable parachute, movable curtain, inflatable funnel, inflatable bladder, etc.). Control of a damper's movement between its initial and operating configurations can be achieved by various actuators, examples of which include, but are not limited to, an air-powered device, an electric motorized device, a spring, a weight, an inflatable bladder, a turbine, a motion-dampening device, a flywheel with rotational inertia, a piston/cylinder, a pliable elongate member (e.g., string, chain, wire, cable, strap, etc.), and/or various combinations thereof.

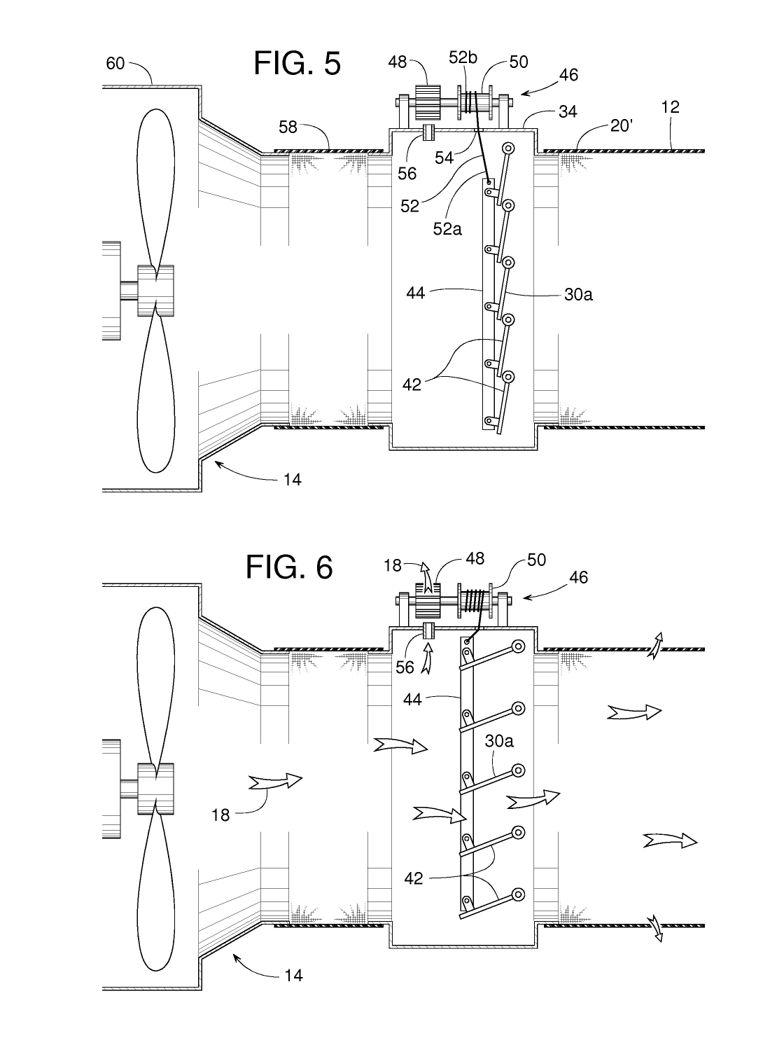

In some examples, the structure of damper 30 is as shown in FIGS. 5 and 6, wherein a damper 30a corresponds to damper 30. In this example, damper 30a is installed within a damper housing 34 disposed at an upstream end 20′ of an inflatable tube 12. Damper 30a is shown in a generally closed initial configuration in FIG. 5 and is shown in a more open operating configuration in FIG. 6. Damper 30a, in this example, includes a series of damper blades 42 pinned to a connecting bar 44 so that damper blades 42 pivot in unison. In some examples, ends of blades 42 may be pivotably coupled to damper housing 34.

In this example, damper 30a is opened by an air-powered actuator 46 comprising a turbine wheel 48 that drives the rotation of a spool 50. A flexible elongate member 52 threaded through a hole or aperture 54 in damper housing 34 has one end 52a attached to bar 44 and an opposite end 52b wrapped around and attached to spool 50.

Operation can begin with blower 14 inactive and damper 30a in its initial configuration of FIG. 5. Blower 14, upon being energized, discharges air 18 against the generally closed damper 30a (in some examples, damper 30a is slightly open in the initial configuration), and some air 18 blows through a nozzle 56 that directs a stream of air 18 across turbine wheel 48. The air through nozzle 56 turns turbine wheel 48 and spool 50 to draw in elongate member 52, which pulls on bar 44 to slowly or controllably open damper 30a. As damper 30a opens, a slowly increasing volume of air 18 passes through damper 30a to gradually increase the static pressure in tube 12 until tube 12 is fully inflated with damper 30a being at its operating configuration of FIG. 6.

When blower 14 is de-energized, airflow decreases through nozzle 56 and damper 30a settles, by its own weight, back down to return to its initial configuration of FIG. 5. As damper 30a moves from its operating position of FIG. 6 to its initial position of FIG. 5, bar 44 pulls on elongate member 52 to back spin spool 50 and turbine wheel 48.

Although damper 30a is shown having its own damper housing 34 with a short section of tube 58 connecting damper housing 34 to a blower housing 60, in some examples, damper 30a is installed within and/or supported by blower housing 60, thereby eliminating tube section 58 and/or separate damper housing 34. Such modifications, similar or identical thereto, may also be applied to other examples disclosed herein.

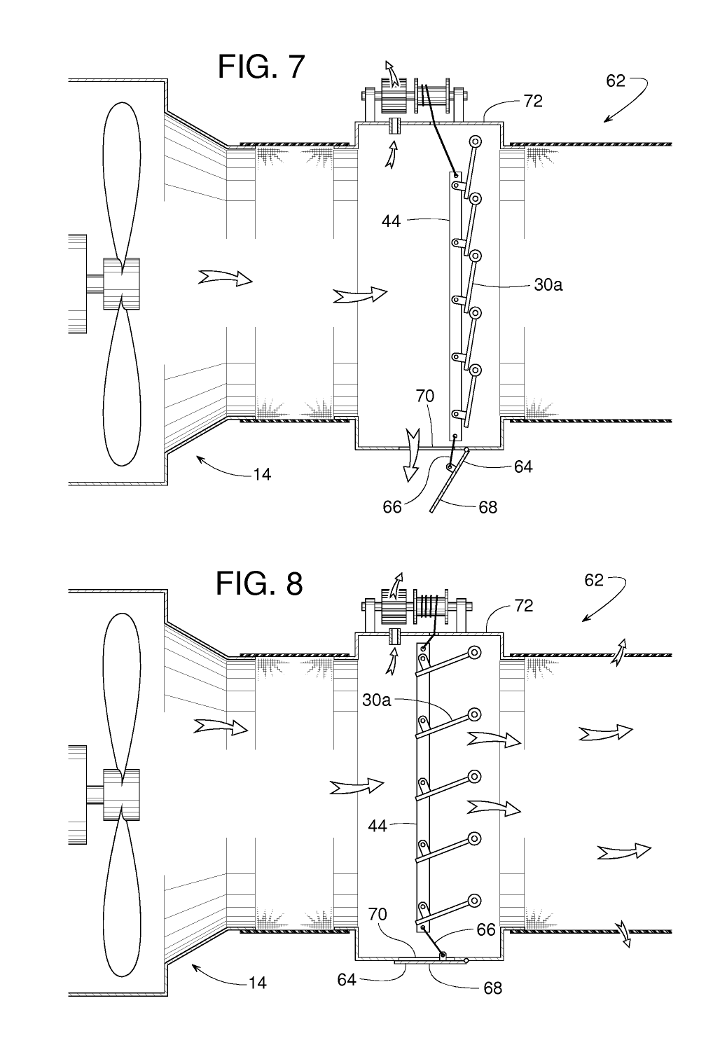

Referring to FIGS. 7 and 8, to reduce the discharge pressure of blower 14 when damper 30a is generally closed in its initial configuration (FIG. 7), an example air duct system 62 includes an example pressure relief valve 64. In this example, a linkage or elongate member 66 connects bar 44 to a flap 68 on valve 64 such that valve 64 opens as damper 30a closes and vice versa. FIG. 8 shows damper 30a in its generally open operating configuration with valve 64 closed to block off an opening or aperture 70 in a damper housing 72. In other respects, the structure and operation of the air duct systems shown in FIGS. 5-8 are similar.

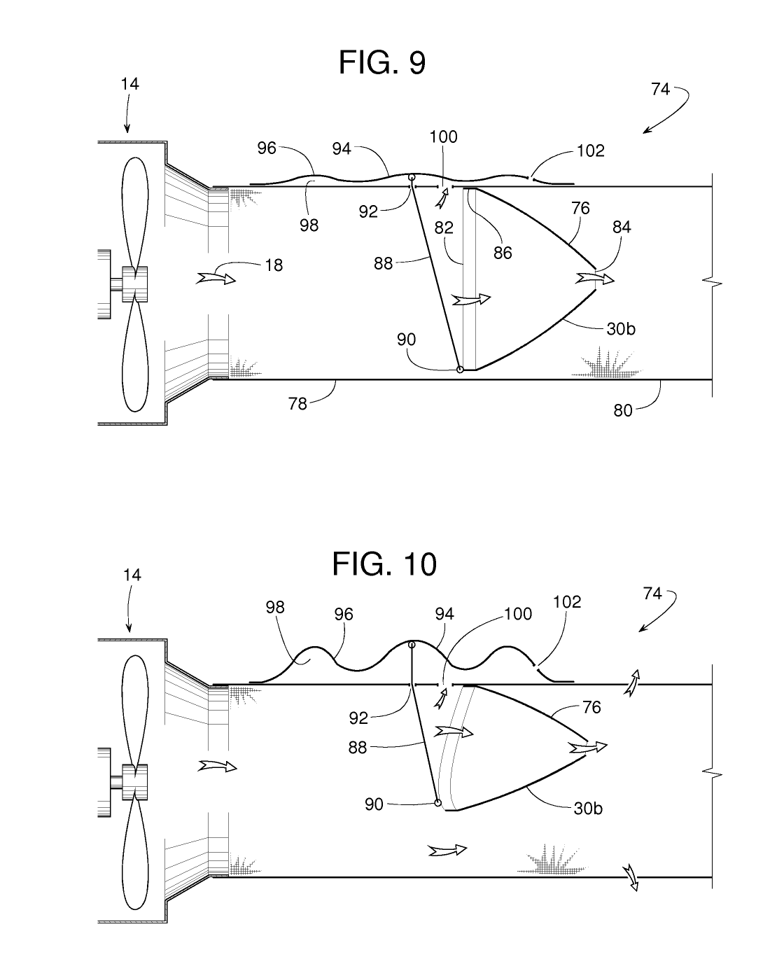

Some example air duct systems, such as example duct system 74 shown in FIGS. 9-12, include a damper 30b in the form of a collapsible funnel 76 made of a pliable sheet of material. Damper 30b may be installed at an upstream end 78 of an inflatable tube 80. FIG. 9 shows damper 30b in an initial configuration to obstruct flow through tube 80, and FIG. 12 shows damper 30b in an operating configuration to provide generally unrestricted airflow. In this example, damper 30b has a wide air inlet 82 at its base and a narrower air outlet 84 at its apex. An upper peripheral section 86 of the inlet's base is attached to an upper sidewall of tube 80 such that funnel-shaped damper 30b tends to hang in its generally expanded initial configuration (FIG. 9), particularly when blower 14 is first energized because blower 14 discharging into inlet 82 tends to force damper 30b to billow outward.

To actuate damper 30b, a flexible elongate member 88 connects to a lower end 90 of damper 30b, feeds through a hole or aperture 92 in the sidewall of tube 80, and connects to a damper actuator 94. In some examples, actuator 94 is an air-powered actuator comprising an inflatable bladder 96 made of a pliable sheet of material. In the illustrated example, bladder 96 overlies an upper portion of tube 80 to create a bladder chamber 98 between the sheet material of bladder 96 and the upper surface of tube 80.

Operation of duct system 74 may begin with damper 30b in its initial configuration, as shown in FIG. 9. Upon energizing blower 14, air 18 forces damper 30b to billow outward to create a significant airflow obstruction that slows the tube's inflation. Initial inflation is achieved by air flowing through outlet 84 and around the outer periphery of damper 30b. Some air 18 discharged from blower 14 also flows through an air passageway 100 in tube 80 to slowly inflate bladder 96. As bladder 96 inflates, elongate member 88 pulls the bottom edge of damper 30b upward, as shown in FIG. 10. As bladder 96 begins collapsing or flattening under the pull of elongate member 88, a greater volume of air 18 flows past damper 30b to inflate tube 80 more fully or with greater pressure.

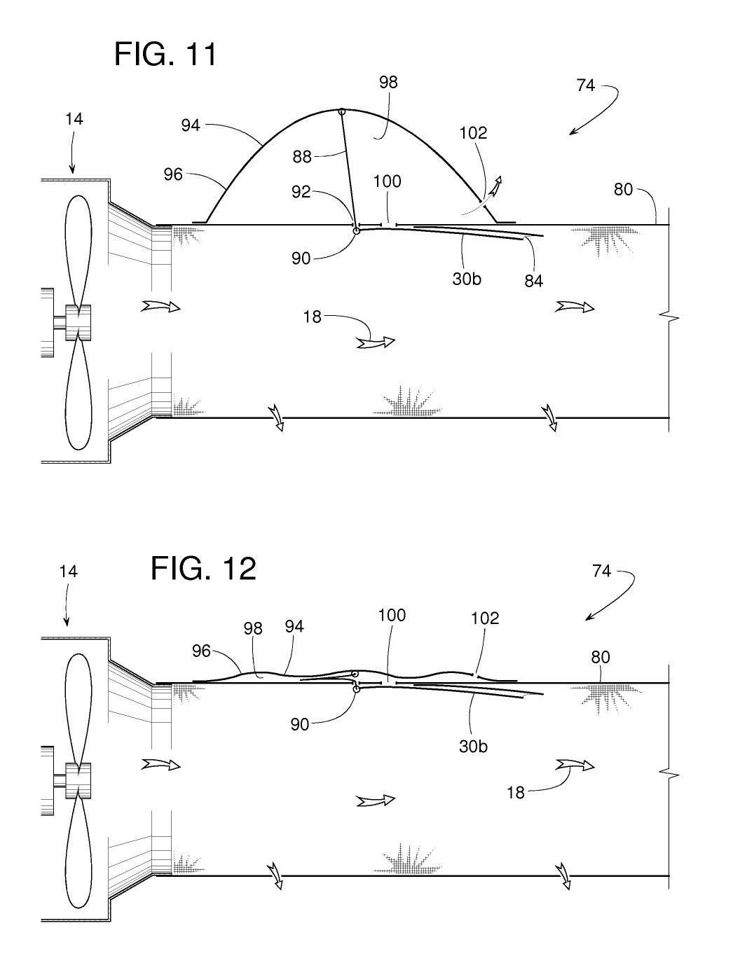

FIG. 11 shows bladder 96 fully expanded and damper 30b fully collapsed. The air pressure in tube 80 helps flatten damper 30b up against the inner wall of tube 80. Damper 30b being collapsed not only provides generally unrestricted flow past damper 30b but also places damper 30b to where the material of damper 30b can block off air passageway 100.

After bladder fully inflates to collapse damper 30b, as shown in FIG. 11, air within chamber 98 slowly leaks out through an opening or aperture 102 in bladder 96. Eventually, bladder 96 collapses generally flat against tube 80, as shown in FIG. 12. With bladder 96 collapsed, air flowing through tube 80 can still hold damper 30b up against the inner wall of tube 80 to maintain generally unrestricted airflow through tube 80. When blower 14 is turned off, bladder 96 is free to fall under its own weight back down to its initial configuration.

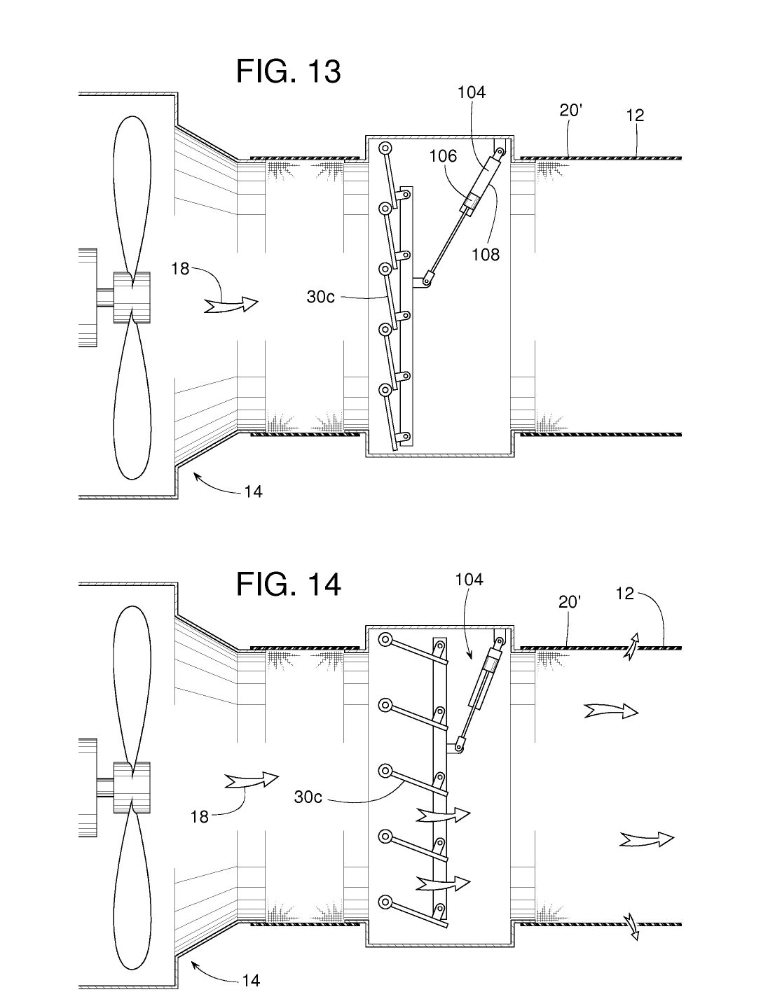

In some examples, the structure of damper 30 of FIGS. 1 and 2 is as shown in FIGS. 13 and 14, wherein a damper 30c corresponds to damper 30. FIG. 13 shows damper 30c at upstream end 36 of tube 12 in an initial configuration, and FIG. 14 shows damper 30c is an operating configuration. Damper 30c is similar to damper 30a of FIGS. 5 and 6; however, damper 30c is blown open by air 18 discharged from blower 14. To slow the tube's rate of inflation, a motion-dampening device 104 is connected to damper 30c. In some examples, device 104 includes a piston 106 and a fluid-filled cylinder 108, wherein the fluid (e.g., air) can leak past or axially through piston 106 to dampen the piston's movement within cylinder 108 and thus dampen the movement of damper 30c.

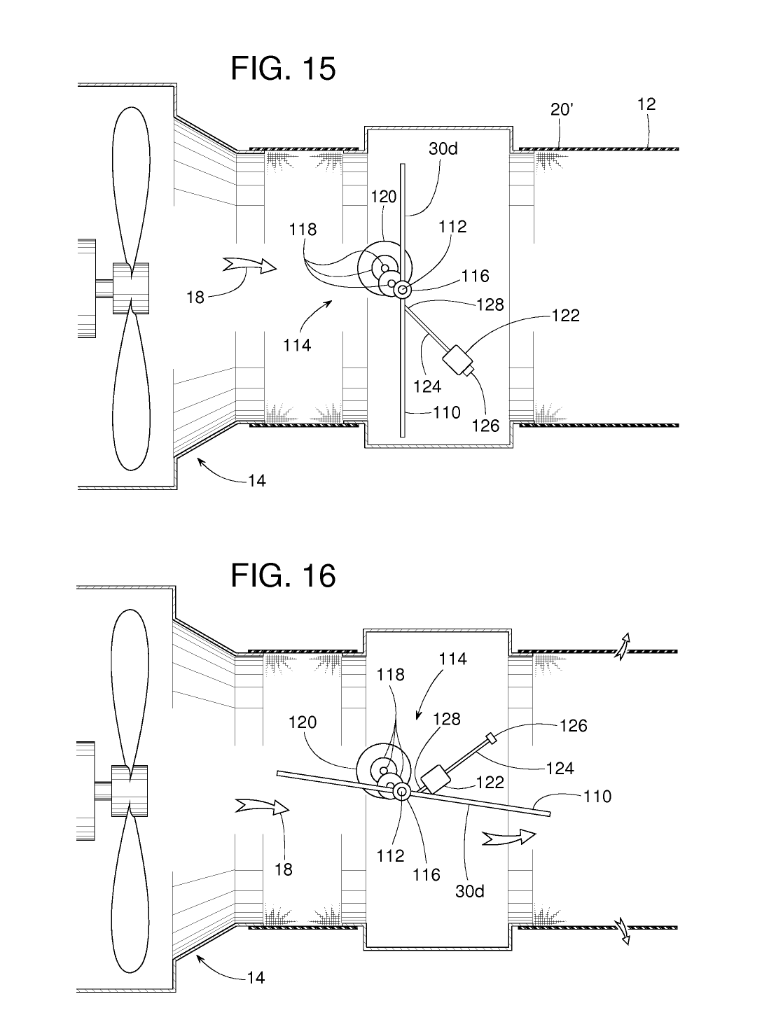

In some examples, the structure of damper 30 of FIGS. 1 and 2 is as shown in FIGS. 15 and 16, wherein a damper 30d corresponds to damper 30. FIG. 15 shows damper 30d at upstream end 20′ of tube 12 in an initial configuration, and FIG. 16 shows damper 30d is an operating configuration. In this example, damper 30d includes a generally round butterfly damper blade 110 rotatable about a pivotal axis 112 that is radially offset from the damper blade's physical centerline such that air 18 discharged from blower 14 urges damper blade 110 to rotate to its open operating configuration of FIG. 16.

To slow the damper blade's pivotal movement and thus slow the tube's rate of inflation, a motion-dampening device 114 is connected to damper blade 110. In this example, device 114 includes a gear 116 fixed to damper blade 110 such that gear 116 and damper blade 110 rotate as a unit. A series of speed-increasing gears 118 couples gear 116 to a flywheel 120 such that flywheel 120 rotates significantly faster than gear 116, thus the flywheel's mass moment of inertia resists the damper's rotational acceleration as damper 30d moves between its initial and operating configurations.

Additionally or alternatively, to resist the movement of damper blade 110, device 114 may include a weight 122 that slides along an arm or rod 124 rigidly extending from damper blade 110. When damper 30d is in the initial configuration of FIG. 15, weight 122 is at a distal end 126 of arm 124 to provide a significant moment that opposes but does not completely stop the damper blade's opening movement. As damper 30d fully opens to the operating configuration shown in FIG. 16, weight 122 slides down toward a proximal end 128 of arm 124. Weight 122 at proximal end 128 reduces the moment that weight 122 exerts against damper blade 110, so air 18 discharged from blower 14 can readily hold damper 30d fully open during normal, steady-state operation.

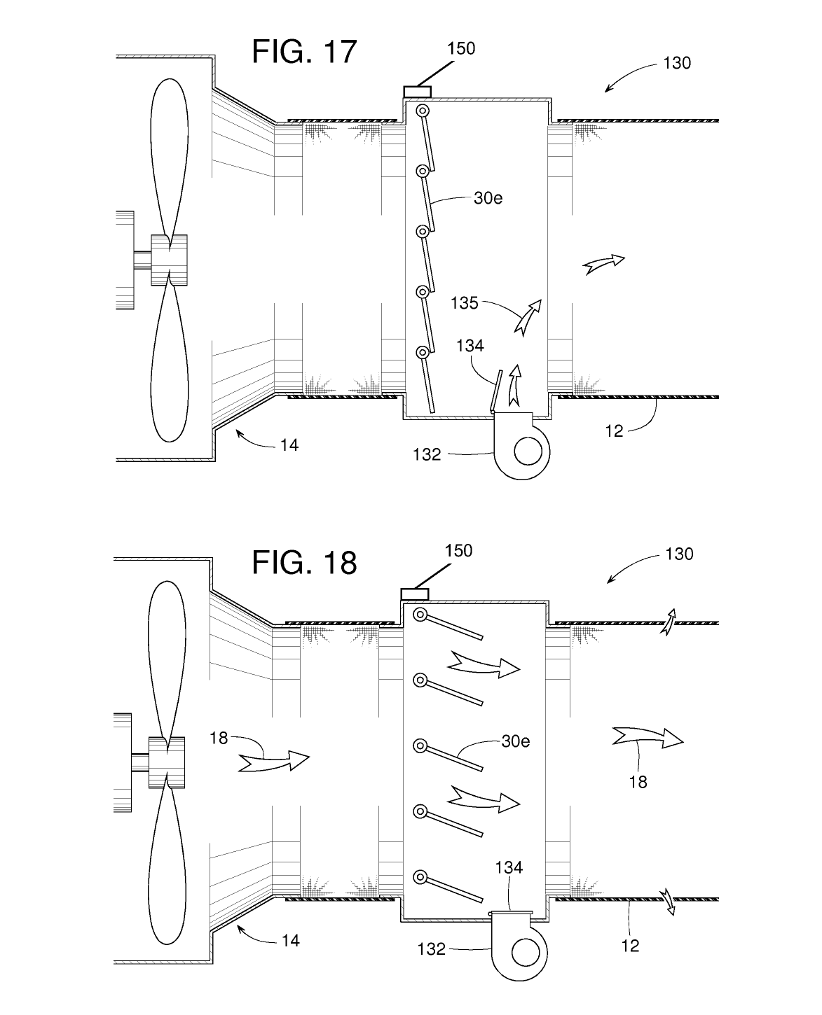

In some examples, as shown in FIGS. 17 and 18, an air duct system 130 slowly inflates tube 12 using an auxiliary source of air (e.g., auxiliary blower 132) that provides an initial current of air 135 at a lower flow rate and/or lower static pressure than that of blower 14. The auxiliary blower 132 may be powered by a power source 150 electrically coupled thereto. In some example, the power source 150 includes one or more batteries. The one or more batteries may be coupled to the blower housing, the damper housing or some other structure, for example. The one or more batteries may be positioned in a battery pack.

In other examples, the power source 150 may include one or more solar panels. The solar panel(s) may be configured to harness energy from incandescent and/or fluorescent light, for example. The solar panel(s) may be positioned adjacent to or at a distance from the auxiliary blower 132. In some examples, the solar panel(s) may be coupled to the blower housing, the damper housing or some other structure.

In this example, a damper 30e (e.g., series of free-swinging damper blades) is disposed downstream of blower 14, and a check valve 134 (e.g., a flap) is downstream of auxiliary blower 132.

In operation, auxiliary blower 132 initially inflates tube 12 with air 135 at a relatively low flow rate, while main blower 14 is inactive with damper 30e closed, as shown in FIG. 17. When there is a greater demand for air in the comfort zone, main blower 14 is activated, and the resulting air 18 discharged from main blower 14 forces damper 30e open. In some examples, the activation of main blower 14 and/or the deactivation of auxiliary blower 132 closes check valve 134, as shown in FIG. 18. In some examples, auxiliary blower 132 operates continuously, regardless of whether main blower 14 is operating. In other examples, auxiliary blower 132 is deactivated upon energizing main blower 14. In still other examples, auxiliary blower 132 is only activated for a time period just prior to activating blower 14. The time period may be related to the amount of time for auxiliary blower 132 to blow sufficient air into tube 12 to reduce or preferably minimize popping and/or shaking that may otherwise occur. Auxiliary blower 132 can be at any location along the length of tube 12.

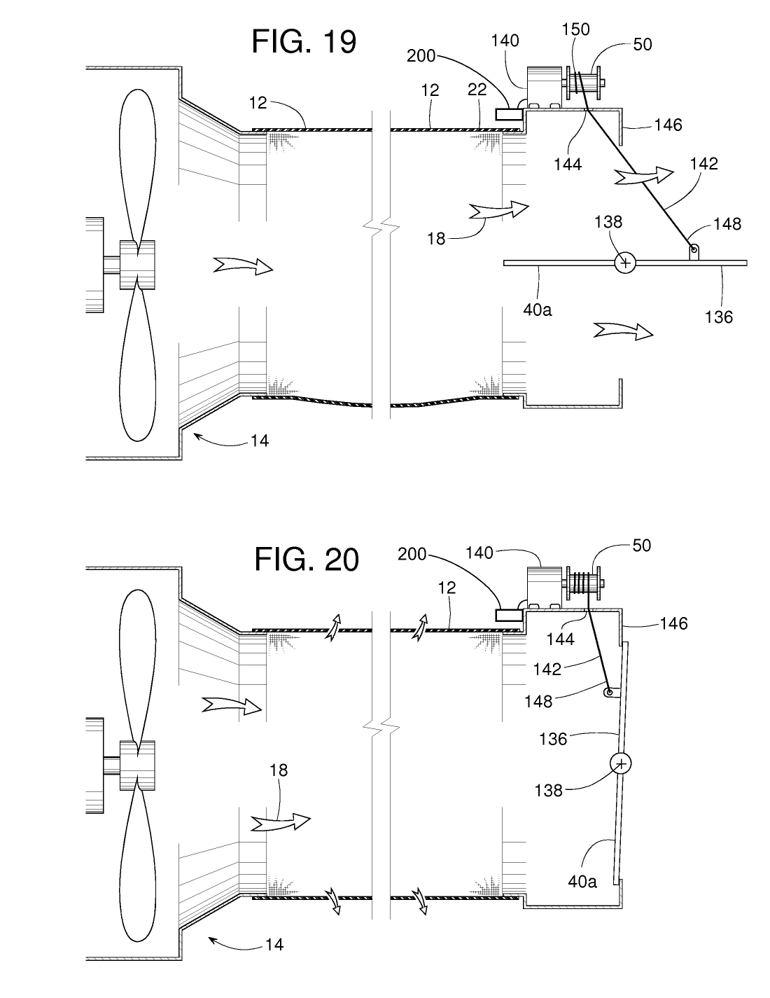

In some examples, the structure of damper 40 of FIGS. 3 and 4 is as shown in FIGS. 19 and 20, wherein a damper 40a corresponds to damper 40. FIG. 19 shows damper 40a at downstream end 22 of tube 12 in an initial configuration, and FIG. 20 shows damper 40a is an operating configuration. In this example, damper 40a includes a generally round butterfly damper blade 136 rotatable about a pivotal axis 138 that is radially offset from the damper blade's physical centerline such that air 18 discharged from blower 14 urges damper blade 136 to rotate to its open initial configuration of FIG. 19. In some examples, the damper blade's center of gravity also urges damper blade 136 to its open initial configuration.

In some examples, damper 40a is closed by a motorized actuator 140 that drives the rotation of spool 50. The motorized actuator 140 may be powered by a power source 200 electrically coupled thereto. In some example, the power source 200 includes one or more batteries. The one or more batteries may be coupled to the blower housing, the damper housing or some other structure, for example. The one or more batteries may be positioned in a battery pack.

In other examples, the power source 200 may include one or more solar panels. The solar panel(s) may be configured to harness energy from incandescent and/or fluorescent light, for example. The solar panel(s) may be positioned adjacent to or at a distance from the motorized actuator 140. In some examples, the solar panel(s) may be coupled to the blower housing, the damper housing or some other structure.

A flexible elongate member 142 threaded through a hole or aperture 144 in a housing 14b has one end 148 attached to damper 40a and an opposite end 150 wrapped around and attached to spool 50.

Operation can begin with blower 14 inactive and damper 40a open in its initial configuration. Upon activating blower 14, tube 12 starts inflating but slowly and not completely because damper 40a being open releases much of the air pressure within tube 12. After tube 12 is partially inflated, motorized actuator 140 is energized to slowly pull damper 40a from its generally open initial configuration of FIG. 19 to its generally closed operating configuration of FIG. 20. Once damper 40a closes to its operating configuration, air 18 discharged from blower 14 can fully inflate tube 12, as shown in FIG. 20. Deactivating blower 14 and backspinning spool 50 allows damper 40a to return to its initial open configuration of FIG. 19 and causes tube 12 to deflate.

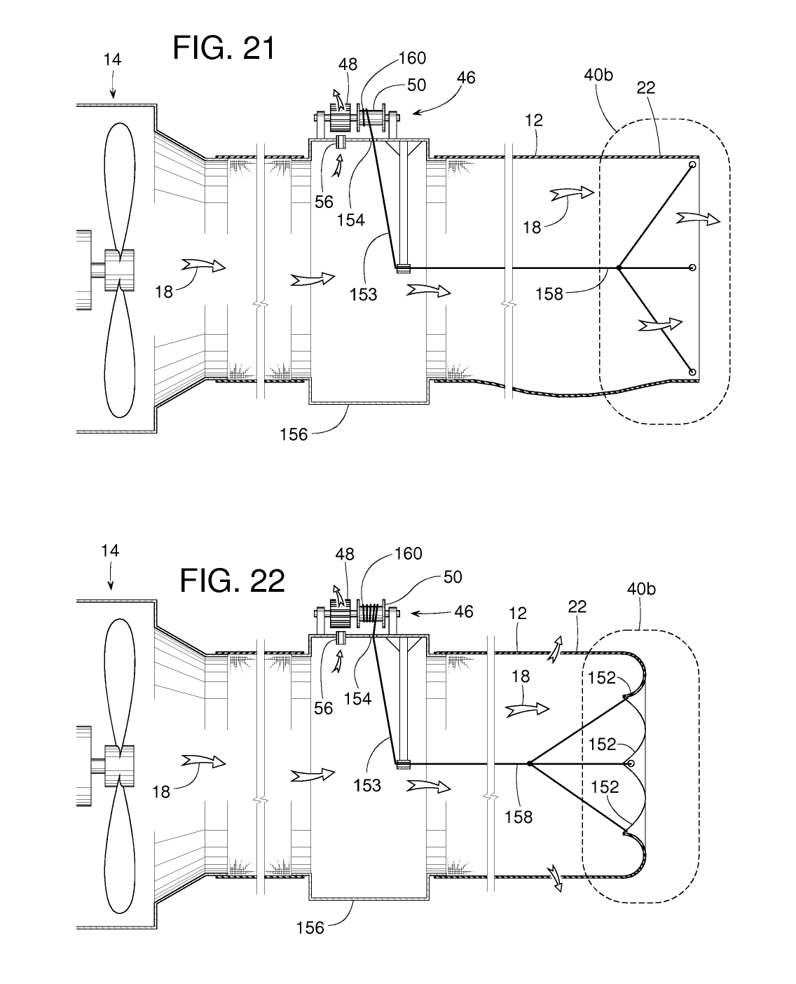

In some examples, the structure of damper 40 of FIGS. 3 and 4 is as shown in FIGS. 21 and 22, wherein a damper 40b corresponds to damper 40. FIG. 21 shows damper 40b at downstream end 22 of tube 12 in an initial configuration, and FIG. 22 shows damper 40b is an operating configuration. In this example, damper 40b includes the material of tube 12 itself, wherein the material can be pulled back into tube 12 to create parachute-like flaps 152 that can obstruct airflow.

In this example, damper 40b is pulled closed by air-powered actuator 46 comprising turbine wheel 48 that drives the rotation of spool 50. A flexible elongate member 153 threaded through a hole or aperture 154 in a housing 156 has one end 158 coupled to each flap 152 of damper 40b and an opposite end 160 wrapped around and attached to spool 50.

Operation can begin with blower 14 inactive and damper 40b open in its initial configuration of FIG. 21. Upon activating blower 14, tube 12 starts inflating but slowly and not completely because damper 40b being open releases much of the air pressure within tube 12. While blower 14 is operating, some air 18 blows through nozzle 56 that directs a stream of air across turbine wheel 48. This turns turbine wheel 48 and spool 50 to draw in elongate member 153, which pulls on flaps 152 to move damper 40b to its more closed operating configuration of FIG. 22. Once damper 40b moves to its operating configuration, air 18 discharged from blower 14 can fully inflate tube 12, as shown in FIG. 22.

In some examples, returning to the initial state shown in FIG. 21 involves deactivating blower 14 and backspinning spool 50 to release the tension in elongate member 153. This allows blower 14, the next time it is activated, to blow damper 40B back out to its initial configuration of FIG. 21. The backspinning of spool 50 can be achieved by various devices such as, for example, a torsion spring that urges spool 50 to its position of FIG. 21. In some examples, motorized actuator 140 (FIGS. 19 and 20) is used instead of air-powered actuator 46.

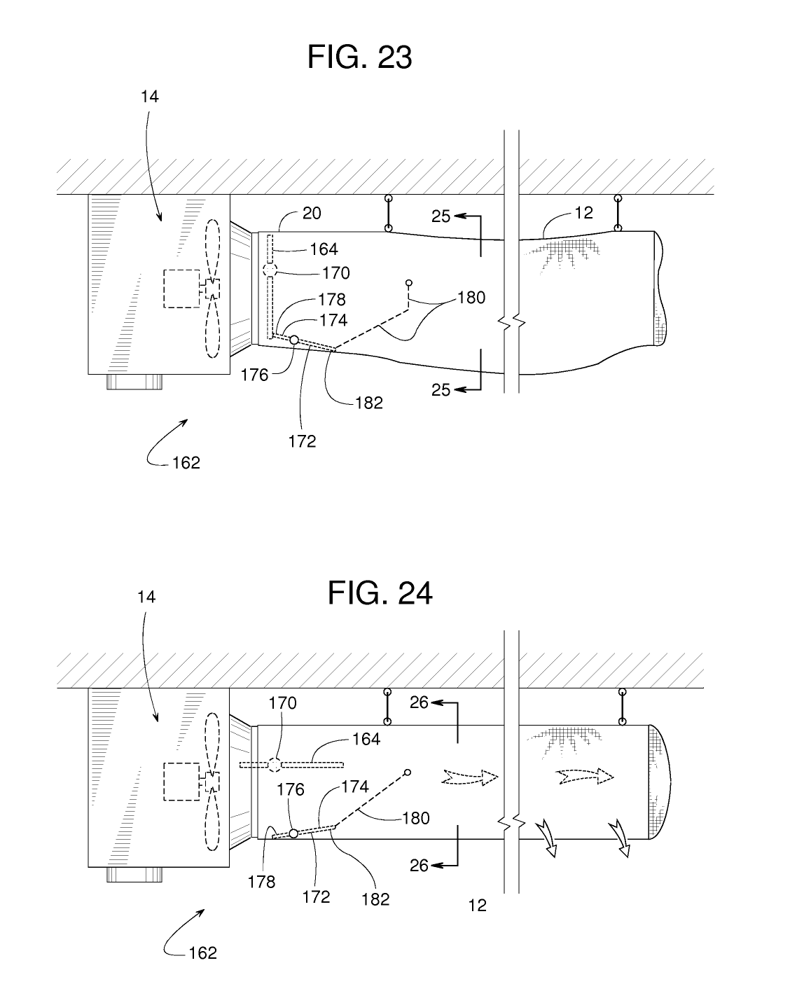

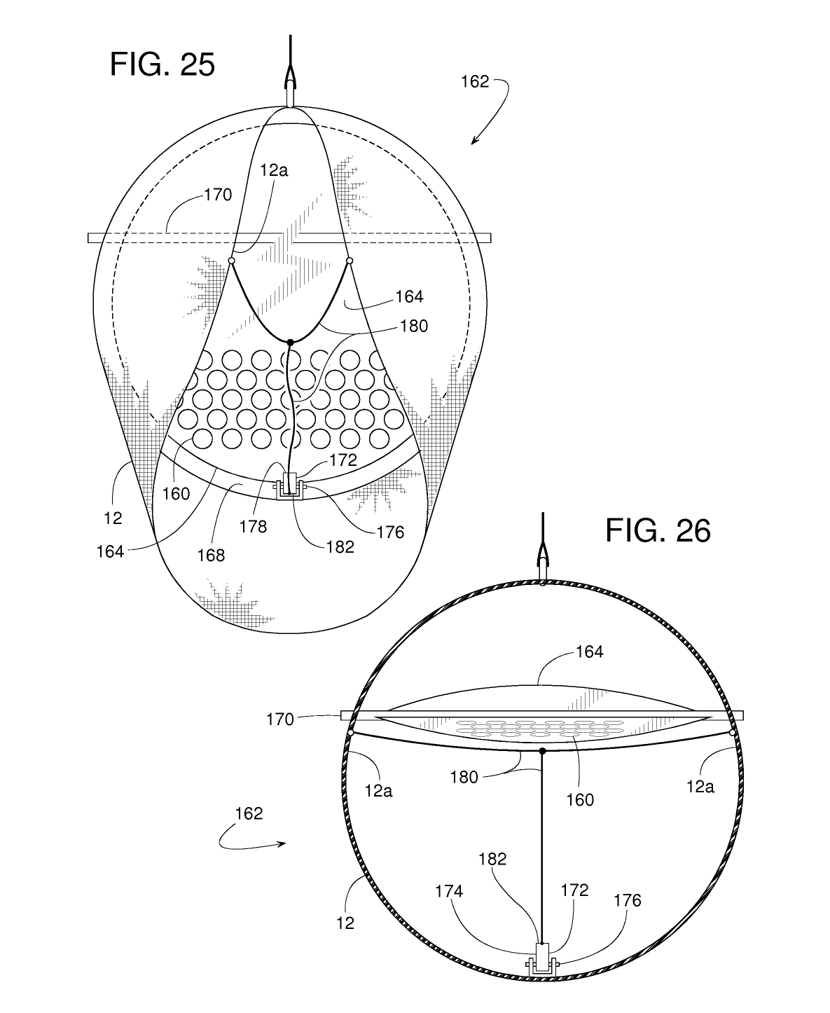

FIGS. 23-26 show an example air duct system 162 comprising an example damper 164 at upstream end 20 of inflatable tube 12. To slowly and controllably inflate tube 12 at startup, damper 164 in an initial configuration (FIGS. 23 and 25) allows limited airflow to pass when blower 14 is first energized. The limited airflow through and/or past damper 164 can be achieved by a porous area 160 (e.g., a screen, an opening, or a series of holes) and/or by a radial clearance 168 between an outer periphery of damper 164 and an inner periphery of tube 12. After tube 12 is partially inflated at the reduced flow rate, damper 164 opens fully to an operating configuration (FIGS. 24 and 26) to complete the tube's inflation at a greater flow rate. In this example, an axle 170 allows damper 164 to pivot between its initial configuration and its operating configuration.

In this example, air discharged from blower 14 urges damper 164 to its operating configuration. At blower startup, however, a trigger or arm 172 engages and holds damper 164 at its initial configuration until tube 12 is partially inflated to a predetermined amount, at which time trigger 172 releases damper 164 so that blower 14 can blow damper 164 fully open to its operating configuration. Later, when blower 14 is de-energized while damper 164 is in its operating configuration, damper 164 swings under its own weight back down to its initial configuration to become reengaged with trigger 172. FIGS. 23 and 25 show trigger 172 in a hold position engaging damper 164, and FIGS. 24 and 26 show trigger 172 in a release position disengaged from damper 164.

The design and actuation of trigger 172 may vary. In some examples, trigger 172 includes an arm 174 that pivots about an axle 176. The arm's center of gravity relative to the position of axle 176 urges trigger 172 to pivot to its hold position, wherein a first edge 178 of trigger 172 engages damper 164. In this example, a flexible elongate member 180 (e.g., string, cord, strap, rope, chain, wire, cable, etc.) connects a second end 182 of trigger 172 to sidewalls 12a of tube 12.

When tube 12 is deflated, as shown in FIG. 25, elongate member 180 is slack. Elongate member 180 being slack allows trigger 172 to tip to its hold position of FIGS. 23 and 25. When blower 14 is energized while trigger 172 is in its hold position and damper 164 is in its initial configuration, blower 14 inflates tube 12 slowly due to the significant flow resistance of damper 164. As tube 12 inflates to the shape shown in FIG. 26, the tube's sidewalls 12a pull elongate member 180 taut, which pulls trigger 172 to its release position of FIG. 24. Trigger 172 releasing damper 164 allows blower 14 to blow damper 164 fully open to its operative configuration of FIG. 24 and complete the tube's inflation. In this example design, sidewall 12a of tube 12 serves as an air-powered actuator that is operatively coupled to damper 164.

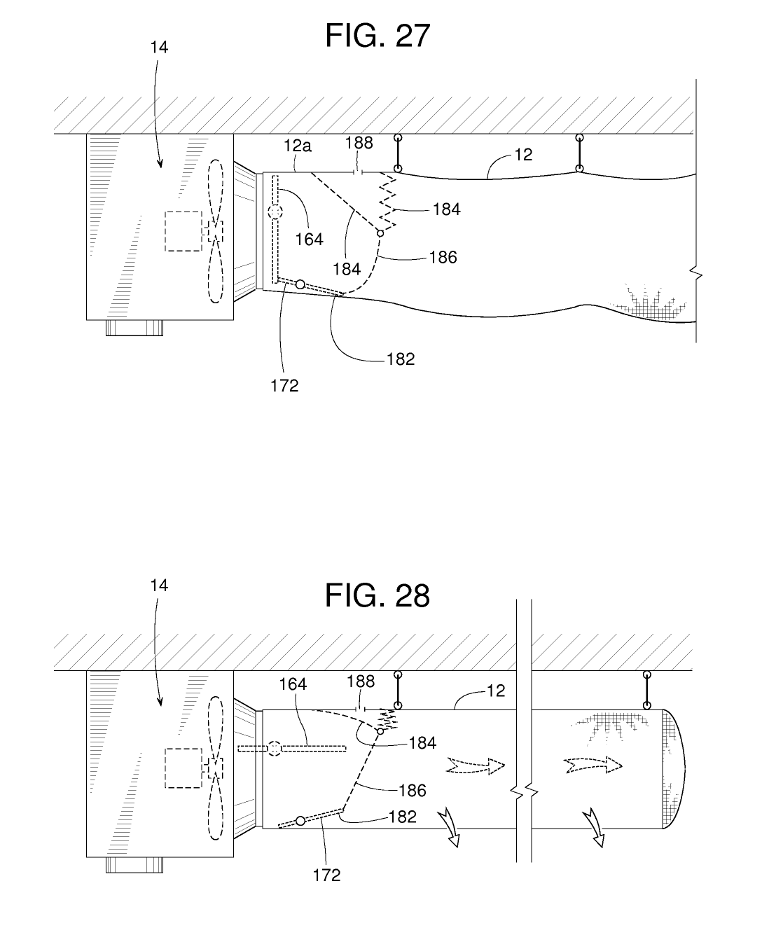

FIGS. 27 and 28 show another example air-powered actuator. In this example, the air-powered actuator includes a collapsible bladder 184 disposed within tube 12. In some examples, bladder 184 is made of a pliable fabric; however, other examples of bladder 184 are comprised of other materials including, but not limited to, a flexible plastic sheet. To trip trigger 172, a flexible elongate member 186 (e.g., string, cord, strap, rope, chain, wire, cable, etc.) connects bladder 184 to end 182 of trigger 172.

FIG. 27 shows damper 164 generally closed in its initial configuration, shows trigger 172 in its hold position engaging damper 164, and shows bladder 184 in a relaxed expanded state. Upon energizing blower 14 under such conditions, limited airflow through and/or past damper 164 slowly inflates tube 12. As tube 12 inflates, the static air pressure within tube 12 increases, which tends to compress bladder 184. Sidewall 12a of tube 12 includes a restricted air passageway 188 (e.g., hole, opening, screen, porous fabric, etc.) that places the air within bladder 184 in restricted fluid communication with atmospheric pressure. Consequently, as the elevated static pressure in tube 12 applies compressive pressure against the bladder's exterior, bladder 184 slowly collapses as air within bladder 184 leaks out to atmosphere through passageway 188. As bladder 184 compresses, bladder 184 pulls elongate member 186 taut, which pulls trigger 172 from its hold position (FIG. 27) to its release position (FIG. 28). Trigger 172 releasing damper 164 allows blower 14 to blow damper 164 fully open to its operative configuration of FIG. 28 and complete the tube's inflation.

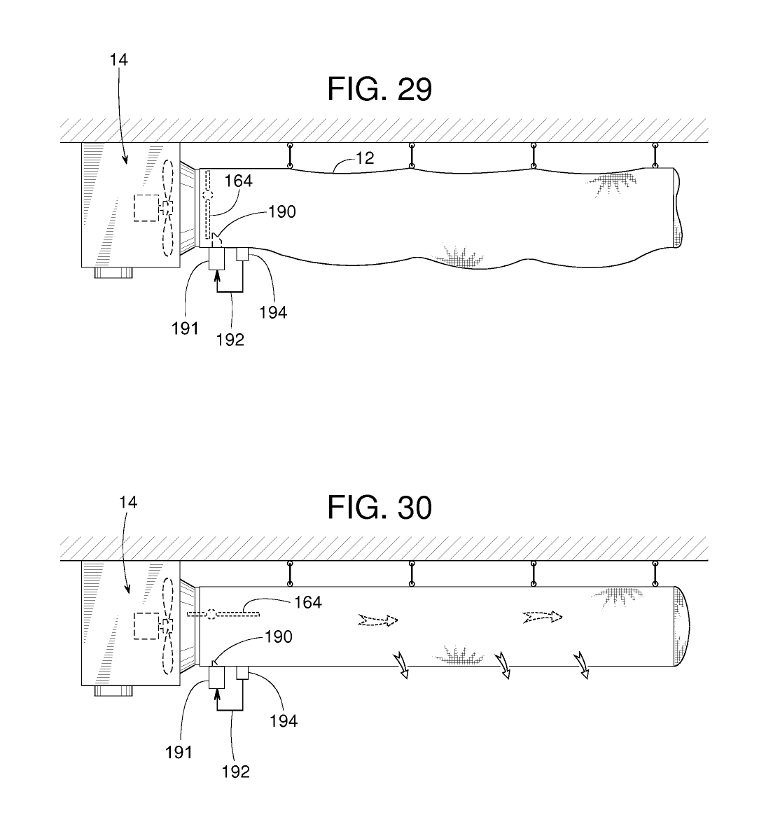

In another example, shown in FIGS. 29 and 30, damper 164 is held to its initial configuration (FIG. 29) by a trigger 190 that is responsive to pressure in tube 12. In some examples, for instance, trigger 190 is a solenoid responsive to a signal 192 from a pressure sensor 194 such that in response to the pressure in tube 12 reaching a predetermined limit sufficient to partially inflate tube 12, sensor 194 provides signal 192 to command solenoid 191 to retract from its hold position of FIG. 29 to its release position FIG. 30. Trigger 190 releasing damper 164 allows blower 14 to blow damper 164 fully open to its operative configuration of FIG. 30 and complete the tube's inflation. Trigger 190 and sensor 194 can be separate items, as shown, or the two can be incorporated into a single assembly.

In the example shown in FIGS. 29 and 30, damper 164 may still include a porous area 160 (e.g., a screen, an opening, or a series of holes) to allow a small percentage of airflow to pass through the damper when blower 14 is first energized. Furthermore, an actuation mechanism other than pressure sensor 194 (e.g., airflow sensor, optical eye, etc.) and trigger 190 could be used to release damper 164 to its fully open position. For example, an actuator could be coupled to axle 170, wherein the actuator includes a timer that begins when the blower 14 is first energized. After a preset amount of time has passed after energizing blower 14, the timer and associated actuator may rotate axle 170, causing damper 164 to open. Alternatively, an actuator could be equipped with a variable speed motor, in which the motor rotates axle 170 very slowly when blower 14 is first energized and then more quickly as time passes, until damper 164 reaches is fully-open position.

Some of the aforementioned examples may include one or more features and/or benefits including, but not limited to, the following:

In some examples, an inflatable air duct is inflated slowly without the need for a damper controlled by an electrically powered actuator.

In some examples, an inflatable air duct is inflated slowly without having to regulate the speed of a supply air blower.

In some examples, an inflatable air duct is sometimes lightly inflated by a relatively small auxiliary blower and at other times is more forcibly inflated by a larger blower.

Although certain example methods, apparatus and articles of manufacture have been described herein, the scope of the coverage of this patent is not limited thereto. On the contrary, this patent covers all methods, apparatus and articles of manufacture fairly falling within the scope of the appended claims either literally or under the doctrine of equivalents.

1. An air duct system connectable to a source of air that is selectively activated and deactivated, the air duct system comprising:
an inflatable tube to convey a current of air from the source of air; and
flow regulating means for slowing a rate at which the static air pressure within the inflatable tube increases upon the source of air being activated, the flow regulating means being in communication with the inflatable tube downstream of the source of air.

2. An air duct system connectable to a source of air that can provide the air duct system with air at a pressure that can vary from a relatively low static air pressure to a relatively high static air pressure, the air duct system comprising:
an inflatable tube having an inflated state and a deflated state; and
a damper in communication with the inflatable tube and being selectively configurable in an initial configuration and an operating configuration, the damper to move from the initial configuration to the operating configuration as the pressure within the inflatable tube changes from the relatively low static air pressure while the inflatable tube is in the deflated state to the relatively high static air pressure while the inflatable tube is in the inflated state.

3. The air duct system of claim 2, wherein the damper is at an upstream end of the inflatable tube and is to provide a greater obstruction to airflow when the damper is in the initial configuration than when the damper is in the operating configuration.

4. The air duct system of claim 2, further comprising a pressure relief valve in communication with the inflatable tube in proximity with the damper, the pressure relief valve to provide a greater obstruction to airflow when the damper is in the operating configuration than when the damper is in the initial configuration.

5. The air duct system of claim 2, wherein the damper is at a downstream end of the inflatable tube and is to provide a greater obstruction to airflow when the damper is in the operating configuration than when the damper is in the initial configuration.

6. The air duct system of claim 2, further comprising a motion-dampening device to resist the movement of the damper from the initial configuration to the operating configuration.

7. The air duct system of claim 6, wherein the motion-dampening device comprises a piston and a cylinder.

8. The air duct system of claim 6, wherein the motion-dampening device includes a flywheel having a mass moment of inertia to resist the movement of the damper.

9. The air duct system of claim 2, further comprising an air-powered actuator coupled to the damper to move the damper under an impetus of the air from the source of air.

10. The air duct system of claim 9, wherein the air-powered actuator comprises a turbine wheel.

11. The air duct system of claim 9, wherein the air-powered actuator comprises an inflatable bladder.

12. The air duct system of claim 9, wherein the air-powered actuator comprises a pliable sheet of material.

13. The air duct system of claim 9, further comprising a flexible elongate member coupling the air-powered actuator to the damper.

14. The air duct system of claim 2, further comprising a motorized actuator coupled to the damper to move the damper between the initial configuration and the operating configuration.

15. The air duct system of claim 14, further comprising a flexible, elongate member coupling the motorized actuator to the damper.

16. The air duct system of claim 2, further comprising a trigger movable between a hold position and a release position such that:
a) in the hold position, the trigger is to engage and hold the damper at the initial configuration, and
b) in the release position, the trigger is to disengage and release the damper, thereby enabling the damper to move to the operating configuration of the damper.

17. The air duct system of claim 16, wherein the trigger is to move in response to a change in pressure within the inflatable tube.

18. The air duct system of claim 16, further comprising a flexible elongate member to connect the trigger to a sidewall of the inflatable tube.

19. The air duct system of claim 16, further comprising a pressure sensor in fluid communication with an inside of the inflatable tube, the pressure sensor to provide a signal that varies with the pressure inside the inflatable tube, the trigger being in communication with the pressure sensor, the trigger is to move in response to the signal.

20. The air duct system of claim 2, wherein the damper includes a porous area.

21. An air duct system connectable to a main source of air that is selectively activated and deactivated, the air duct system comprising:
an inflatable tube conveying a current of air at a first airflow rate provided by the main source of air when the main source of air is activated; and
an auxiliary source of air in fluid communication with the inflatable tube to provide an initial current of air at a second airflow rate that is less than the first airflow rate.

22. The air duct system of claim 21, further comprising a damper downstream of the main source of air, the damper being more open when the main source of air is activated than when the main source of air is deactivated.

23. The air duct system of claim 21, further comprising a check valve to be disposed in series-flow relationship with the initial current of air from the auxiliary source of air.

24. An air duct method that involves the use of an inflatable tube, a main source of air, and an auxiliary source of air, the air duct method comprising:
activating the auxiliary source of air while the main source of air is deactivated, thereby at least partially inflating the inflatable tube with air at a first static pressure; and
activating the main source of air to pressurize the inflatable tube at a second static pressure that is greater than the first static pressure.

25. The air duct method of claim 24, further comprising deactivating the auxiliary source of air so that the auxiliary source of air is deactivated while the main source of air is activated.
